(19) United States
(12) Patent Application Publication
(10) Pub. No.: US 2005/0140990 A1
(43) Pub. Date: Jun. 30, 2005

(54) Image processing apparatus and method and image data display method for digital camera

(76) Inventors: Akira Ueno, Akiruno-shi (JP); Yoshinobu Tanaka, Hachioji-shi (JP); Dai Kawase, Hino-shi (JP)

Correspondence Address: STRAUB & POKOTYLO, 620 TINTON AVENUE, BLDG. B, 2ND FLOOR, TINTON FALLS, NJ, 07724, US

(21) Appl. No.: 10/962,180

(22) Filed: Oct. 8, 2004

(30) Foreign Application Priority Data
Oct. 15, 2003 (JP) 2003-355458
Nov. 13, 2003 (JP) 2003-383875

(51) Int. Cl. H04N 1/393; G06T 3/40

(52) U.S. Cl. 358/1.2; 382/298; 358/451

(57) ABSTRACT

An image processing apparatus processes image data two-dimensionally arrayed in vertical and horizontal directions. A vertical size changing section changes a size of the image data in the vertical direction. A horizontal size changing section changes the size of the image data changed by the vertical size changing section in the horizontal direction. A display section displays the image data changed in size in the vertical and horizontal directions.

### CROSS-REFERENCE TO RELATED APPLICATIONS

This application is based upon and claims the benefit of priority from prior Japanese Patent Applications No. 2003-355458, filed Oct. 15, 2003; and No. 2003-383875, filed Nov. 13, 2003, the entire contents of both of which are incorporated herein by reference.

### BACKGROUND OF THE INVENTION

1. Field of the Invention

The present invention relates to an image processing apparatus, an image processing method, and an image data display method in, e.g., a digital camera.

2. Description of the Related Art

In an electronic image acquisition apparatus such as a digital camera, image data obtained by a solid-state image acquisition device such as a CCD constituted of pixels two-dimensionally arrayed in vertical and horizontal directions is subjected to predetermined image processing before it is stored or displayed. FIG. 4 shows a schematic constitution of an image processing apparatus which executes such image processing. The image processing apparatus comprises an image processing unit 110, a storage unit (SDRAM) 120, and an image data output unit 130.

To begin with, description will be made of a process when image data obtained by imaging an object is subjected to JPEG compression and stored. The image data obtained by a CCD (not shown) is first stored in an image storage section 120-1 of the SDRAM 120. The image data is read by the image processing unit 110, and subjected to color conversion from RGB to YC by a YC generation section 110-1. Next, the image data is changed (resized) in size in horizontal and vertical directions to be a field angle suited to JPEG processing by a resizing (Cubic) section 110-2 as a size changing section. In the resizing of the vertical direction, for example, processing such as thinning or inserting is carried out. In the resizing of the horizontal direction, for example, 2-point interpolation or 4-point Cubic interpolation is used.

At a JPEG processing section 110-3 as a compressed data generation section, JPEG compression is executed for the resized image data. The image data subjected to the JPEG compression is stored in a JPEG storage section 120-3 of the SDRAM 120.

Next, description will be made of a process when the image data obtained by imaging the object is displayed. The image data obtained by the CCD (not shown) is first stored in the image storage section 120-1 of the SDRAM 120. The image data is read by the image processing unit 110, and subjected to color conversion from RGB to YC by the YC generation section 110-1. Next, the image data is changed in size in the horizontal and vertical directions to be a field angle suited to image outputting by the resizing section 110-2. The image data changed in size is temporarily stored in a YC storage section 120-2 of the SDRAM 120.

On the other hand, under control of a CPU 140, On Screen Display (OSD) data suited to a color pallet 130-2 is selected and read from OSD's 1 to 3 (120-4 to 120-6), and sent to a superimposing section (MIX) 130-3 of the image data output unit 130. The superimposing section 130-3 superimposes the ODS data on the image data read from the YC storage section 120-2. The image data on which the ODS data has been superimposed is output from the image data output unit 130, and displayed by a display unit 150. A specific example of the display unit 150 may be a liquid crystal display (LCD), a TV apparatus or the like.

Jpn. Pat. Appln. KOKAI Publication No. 2001-61058 discloses an example of an image processing apparatus which carries out the aforementioned image processing. Image data read from a DRAM 20 is supplied to variable power circuits 30, 32. The variable power circuit 30 changes an image size for compression and recording, and the variable power circuit 32 changes the image size for displaying.

Furthermore, Published Japanese Patent No. 3110789 discloses an image recording/reproducing apparatus which cuts out a part of a reproduced image in response to an operation of operation means during image reproduction, and enlarges the cut-out part to execute electronic zooming.

### BRIEF SUMMARY OF THE INVENTION

A first aspect of the present invention is directed to an image processing apparatus which processes image data two-dimensionally arrayed in vertical and horizontal directions, comprising:
a vertical size changing section which changes a size of the image data in the vertical direction;
a horizontal size changing section which changes the size of the image data changed by the vertical size changing section in the horizontal direction; and
a display section which displays the image data changed in size in the vertical and horizontal directions.

A second aspect of the present invention is directed to an image processing apparatus which processes image data two-dimensionally arrayed in vertical and horizontal directions, comprising:
a first storage section which stores the image data;
an image processing section which reads the image data stored in the first storage section to execute predetermined image processing therefor;
a size changing section which changes a size of the image data from the image processing section;
a vertical size changing section which changes the size of the image data from the size changing section in the vertical direction;
a second storage section which stores the image data from the vertical size changing section;
a horizontal size changing section which reads the image data stored in the second storage section to change the size of the image data in the horizontal direction; and
a display section which displays the image data changed in size in the vertical and horizontal directions.

A third aspect of the present invention is directed to an image processing apparatus which processes image data two-dimensionally arrayed in vertical and horizontal directions, comprising:
a vertical size changing section which changes a size of the image data in the vertical direction;
a storage section which stores the image data changed by the vertical size changing section;
a horizontal size changing section which reads the image data stored in the storage section to change the size of the image data in the horizontal direction; and
a display section which displays the image data changed in size in the vertical and horizontal directions.

A fourth aspect of the present invention is directed to an image processing method which processes image data two-dimensionally arrayed in vertical and horizontal directions, comprising:
a step of changing a size of the image data in the vertical direction;
a step of changing the size of the image data changed in the vertical direction in the horizontal direction; and
a step of displaying the image data changed in size in the vertical and horizontal directions.

A fifth aspect of the present invention is directed to an image processing apparatus which processes image data two-dimensionally arrayed in vertical and horizontal directions, comprising:
a size changing section which changes a size of the image data;
a JPEG processing section which executes JPEG compression for the image data changed by the size changing section;
a vertical size changing section which changes the size of the image data changed by the size changing section in the vertical direction in parallel with the JPEG compression of the JPEG processing section;
a horizontal size changing section which changes the size of the image data changed by the vertical size changing section in the horizontal direction; and
a display section which displays the image data changed in size in the vertical and horizontal directions.

A sixth aspect of the present invention is directed to an image processing apparatus which processes image data two-dimensionally arrayed in vertical and horizontal directions, comprising:
a storage section which stores the image data at least before execution of image processing and even after the execution of the image processing;
a first data sequence conversion section which reads, with a block of the two-dimensionally arrayed image data as a unit, the image data of the block from the storage section in a line direction, and then outputs the image data of the block in a column direction;
an image processing section which receives the image data output from the first data sequence conversion section in the column direction, changes a size of the image data and then outputs the image data in the column direction;
a second data sequence conversion section which converts the image data output from the image processing section in the column direction into image data of the line direction, and outputs the image data;
a JPEG processing section which executes JPEG compression for the image data of the line direction from the second data sequence conversion section;
a vertical size changing section which changes the size of the image data of the column direction from the image processing section in the vertical direction;
a third data sequence conversion section which converts the image data output from the vertical size changing section in the column direction into image data of the line direction, and outputs the image data;
a horizontal size changing section which changes the size of the image data of the line direction from the third data sequence conversion section in the horizontal direction; and
a display section which displays the image data changed in size in the vertical and horizontal directions.

A seventh aspect of the present invention is directed to an image data display method comprising:
a first step of changing a size of image data and displaying the image data; and
a second step of generating and displaying image data different from the image data changed and displayed by the size changing processing while the size of the image data is changed in the first step.

An eighth aspect of the present invention is directed to an image data display method comprising:
a step of starting processing to change a size of image data by a first method when changing of the size of the image data and displaying of the image data are instructed;
a step of sequentially generating and displaying image different in size by a second method different from that of the size changing processing while the size of the image data is changed; and
a step of replacing, upon completion of the size changing of the image data by the first method, the image data changed in size and displayed by the second method by the image data changed in size by the first method, and displaying the image data.

A ninth aspect of the present invention is directed to an image data display method comprising:
a step of sequentially generating, when changing of a size of image data and displaying of the image data are instructed, image data different in size by a first method while the size changing is instructed;
a step of stopping the size changing carried out by the first method when the size changing instruction is stopped;
a step of generating image data of a size corresponding to a size of the image data at the time of stopping the size changing carried out by the first method by a second method different from the first method; and
a step of replacing, upon completion of the generation of the image data by the second method, the image data changed in size and displayed by the first method by the image data generated by the second method and displaying the image data.

A tenth aspect of the present invention is directed to an image data display method comprising:
a first step of sequentially generating image data different in size by a first method when changing of a size of image data and displaying of the image data are instructed;
a second step of starting generation of image data changed in size by a second method different from the first method when a size changing rate of the image data exceeds a predetermined size changing rate during the displaying of the image data in the first step; and
a third step of replacing, upon completion of the generation of the image data by the second method, the image data changed in size and displayed by the first method by the image data generated by the second method and displaying the image data.

An eleventh aspect of the present invention is directed to an digital camera comprising:
an image acquisition device which comprises pixels two-dimensionally arrayed in vertical and horizontal directions;
a vertical size changing section which changes a size of image data obtained by imaging an object by the image acquisition device in the vertical direction;
a horizontal size changing section which changes the size of the image data changed by the vertical size changing section in the horizontal direction; and
a display section which displays the image data changed in size in the vertical and horizontal directions.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a block diagram showing a schematic constitution of an image processing apparatus according to a first embodiment of the present invention;

FIG. 2 is a block diagram showing a schematic constitution of an image processing apparatus according to a second embodiment of the invention;

FIGS. 3A to 3D are views explaining data sequence conversion processing;

FIG. 4 is a block diagram showing a schematic constitution of a conventional image processing apparatus;

FIG. 5 is a block diagram showing a schematic system configuration of an electronic image acquisition apparatus to realize an image data display method according to the invention;

FIGS. 6A, 6B are views explaining details of an image data display method according to a third embodiment of the invention;

FIG. 7 is a view explaining details of an image data display method according to a fourth embodiment of the invention;

FIG. 8 is a view explaining details of an image data display method according to a fifth embodiment of the invention; and

FIG. 9 is a view explaining a process when reduced display is carried out.

### DETAILED DESCRIPTION OF THE INVENTION

### First Embodiment

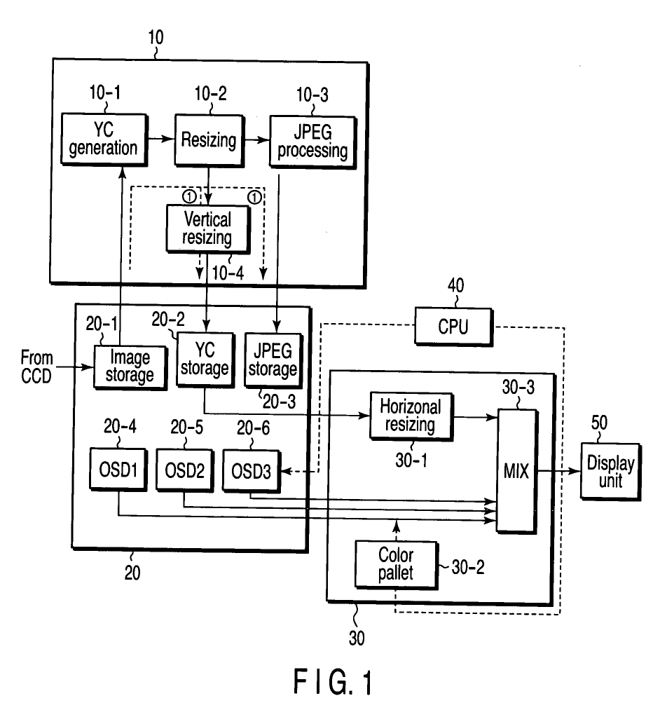

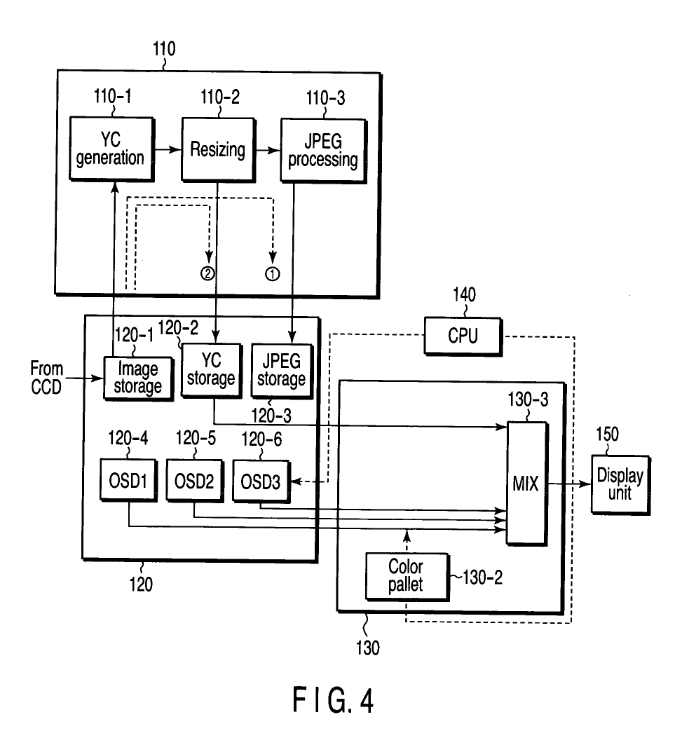

Next, a first embodiment of the present invention will be described in detail with reference to the accompanying drawings. FIG. 1 is a block diagram showing a schematic constitution of an image processing apparatus according to the first embodiment of the invention. The image processing apparatus comprises an image processing unit 10, a storage unit (SDRAM) 20, and an image data output unit 30. The image processing unit 10 of the embodiment is characterized by comprising a vertical resizing section 10-4 as a vertical size changing section disposed at a stage after a resizing section 10-2 to resize image data in a vertical direction in addition to a YC generation section 10-1 equivalent to the YC generation section 110-1 of the aforementioned image processing unit 110 of FIG. 4, the resizing section 10-2 equivalent to the resizing section 110-2, and a JPEG processing section 10-3 equivalent to the JPEG processing section 110-3.

The image data output unit 30 of the embodiment is characterized by comprising a horizontal resizing section 30-1 as a horizontal size changing section disposed at a stage before a superimposing section (MIX) 30-3 to resize the image data read from the YC storage section 20-2 in a horizontal direction in addition to a color pallet 30-2 equivalent to the color pallet 130-2 of the image data output unit 130 of FIG. 4 and the superimposing section (MIX) 30-3 equivalent to the superimposing section (MIX) 130-3.

The image data obtained by a CCD (not shown) which comprises pixels two-dimensionally arrayed in the vertical and horizontal directions is first stored in the image storage section 20-1 of the SDRAM 20. The image data is read by the image processing unit 10, and subjected to color conversion from RGB to YC by the YC generation section 10-1. Next, the image data is changed in size (resized) in the horizontal and vertical directions by the resizing section 10-2 to be a field angle suited to JPEG processing. In the resizing of the vertical direction, for example, processing such as thinning or inserting is carried out. In the resizing of the horizontal direction, for example, 2-point interpolation or 4-point Cubic interpolation is used.

At the JPEG processing section 10-3, the image data changed in size is subjected to JPEG compression. The image data subjected to the JPEG compression is stored in the JPEG storage section 20-3 of the SDRAM 20.

The image data resized by the resizing section 10-2 is sent to the JPEG processing section 10-3, simultaneously sent to the vertical resizing section 10-4, and a size of the image data is changed in the vertical direction to be a field angle suited to image outputting. Subsequently, the image data is stored in the YC storage section 20-2 of the SDRAM 20.

At the time of displaying, the image data stored in the YC storage section 20-2 is read by the image data output unit 30, and the size of the image data is changed in the horizontal direction by the horizontal resizing section 30-1 to be a field angle suited to image outputting. The image data changed in size in the vertical and horizontal directions is sent to the superimposing section (MIX) 30-3.

At this time, under control of the CPU 40, On Screen display (OSD) data suited to the color pallet 30-2 is selected and read from OSD's 1 to 3 (20-4 to 20-6), and sent to the superimposing section (MIX) 30-3 of the image data output unit 30. The superimposing section 30-3 superimposes the OSD data on the image data read from the YC storage section 20-2. The image data on which the OSD data has been superimposed is output from the image data output section 30, and displayed by the display unit 50. A specific example of the display unit 50 may be a liquid crystal display (LCD), a TV apparatus or the like.

As described above, according to the first embodiment, the vertical resizing section 10-4 is disposed in the image processing unit 10, and the horizontal resizing section 30-1 is disposed in the image data output unit 30. At the vertical resizing section 10-4, the image data of the field angle suited to the JPEG processing is further resized in the vertical direction to be changed to a field angle suited to image outputting. At the horizontal resizing section 30-1, the image data of the field angle suited to he JPEG processing is further resized in the horizontal direction to be changed to a field angle suited to image outputting. Thus, the field angles suited to the JPEG processing and the image outputting are obtained by only one image processing (making a round of the image processing unit), whereby a processing time can be shortened.

Furthermore, after being resized in the vertical direction by the vertical resizing section 10-4, the image data is temporarily stored in the SDRAM 20, and then read from the SDRAM 20 to be resized in the horizontal direction by the horizontal resizing section 30-1. Thus, memory access can be efficiently carried out.

### Second Embodiment

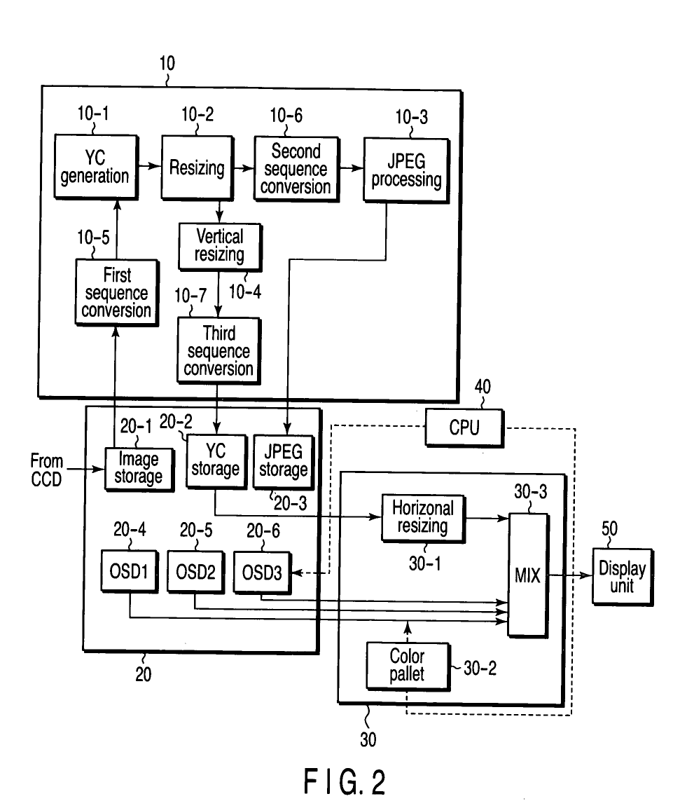

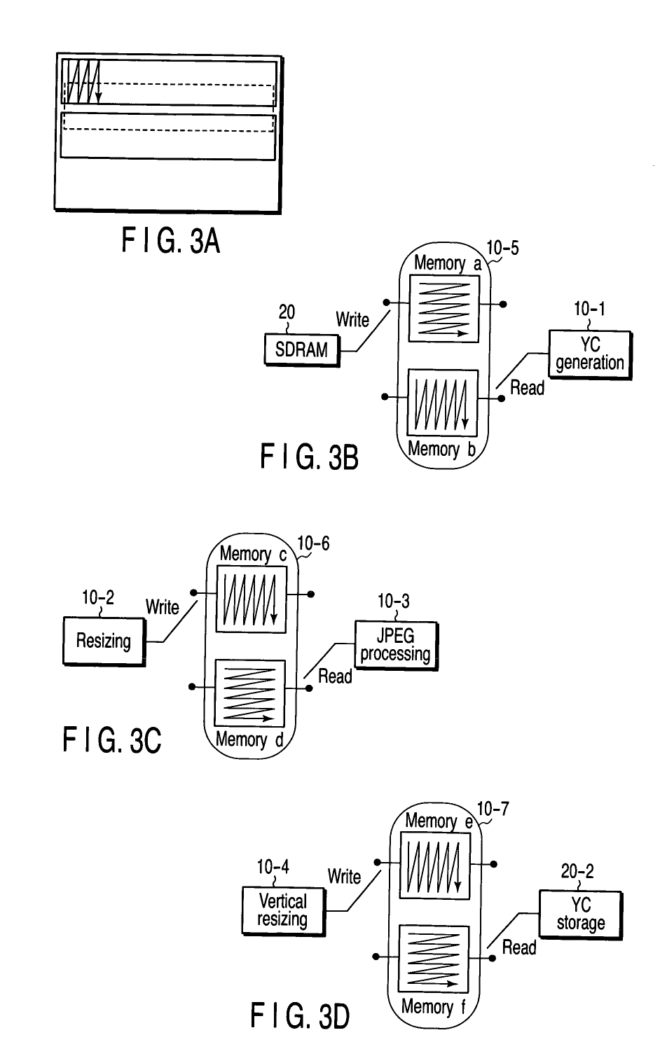

FIG. 2 is a block diagram showing a schematic constitution of an image processing apparatus according to a second embodiment of the invention. FIGS. 3A to 3D are views explaining data sequence conversion processing.

The image processing apparatus of the second embodiment is characterized by comprising, in addition to the components of the image processing apparatus 10 of FIG. 1, a first data sequence conversion section 10-5 disposed at a stage before the YC generation section 10-1, a second data sequence conversion section 10-6 disposed between the resizing section 10-2 and the JPEG processing section 10-3, and a third data sequence conversion section 10-7 between the vertical resizing section 10-4 and the YC storage section 20-2 in the image processing unit 10.

That is, as shown in FIG. 3B, according to the second embodiment, a data sequence is converted by the first data sequence conversion section 10-5 before execution of image processing such as YC generation and resizing. As shown in FIGS. 3C, 3D, after image processing such as resizing, the data sequence is converted by the second data sequence conversion section 10-6 and the third data sequence conversion section 10-7. FIG. 3A shows image data of one screen stored in the SDRAM 20.

To begin with, an operation of the first data sequence conversion section 10-5 will be described. In the SDRAM, burst transfer reading is generally executed to realize high-speed reading in terms of characteristics. Here, data read in a line direction by the burst transfer reading must be rearrayed in a column direction, and input to the YC generation section 10-1. Thus, as shown in FIG. 3B, two small memories a, b (double buffer) having capacities of burst length×basic unit are prepared, and the data read from the SDRAM 20 is written in the memory a and the memory b in a switching manner. During data writing in one memory a, data written in the other memory b is read in the column direction (as is shown in the figure), and input to the YC generation section 10-1. Next, the data read from the SDRAM 20 is written in the memory b. During the writing, the data written in the memory a is read in the column direction, and input to the YC generation section 10-1. Thereafter, similarly, a switching operation of the two memories a, b is carried out to input processed data of the line direction to the YC generation section 10-1.

Next, an operation of the second data sequence conversion section 10-6 will be described. As shown in FIG. 3C, in the sequence conversion operation, two memories c and d (double buffer) having predetermined capacities are used, and data output from the resizing section 10-2 is alternately written in the memory c and the memory d in a switching manner. For the memory c and the memory d, constitutions of 8×8 or 16×16 are generally used. The data output from the resizing section 10-2 are arrayed in a column direction, but input data necessary for the JPEG processing section 10-3 are arrayed in a line direction. Thus, first, while the data from the resizing section 10-2 is written in the memory c, data written in the other memory d is read in the line direction (shown), and input to the JPEG processing section 10-3.

Incidentally, since an operation of the third data sequence conversion section 10-7 is similar to that of the second data sequence conversion section 10-6, detailed description thereof will be omitted.

According to the second embodiments, effects similar to those of the first embodiment can be obtained.

The first and second embodiments have been described by way of case in which the invention is applied to the digital camera. However, the invention is not limited to the digital camera. Needless to say, the invention can be applied to a digital portable device such as a portable telephone equipped with a camera, PDA or the like.

### Third Embodiment

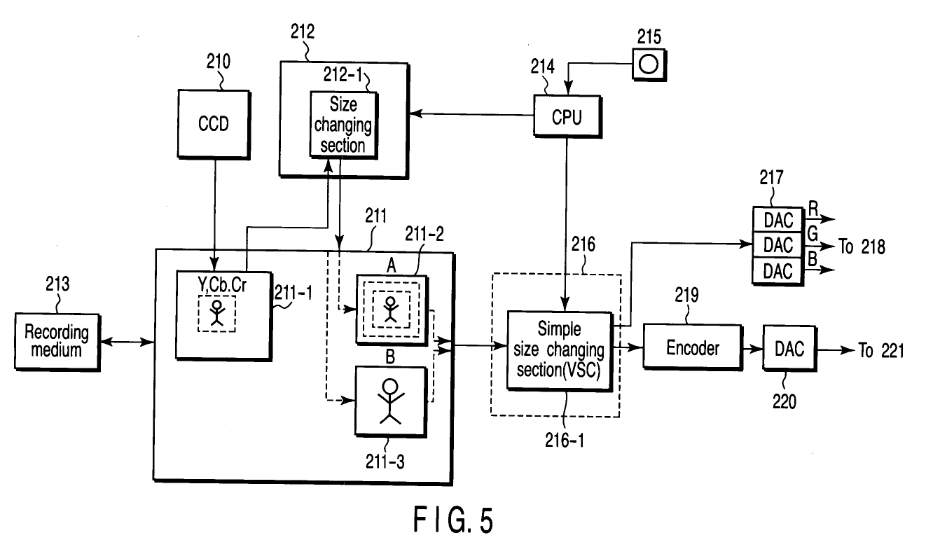

FIG. 5 is a block diagram showing a schematic system configuration of an electronic image acquisition apparatus to realize an image data display method according to a third embodiment. A CCD 210 as an image acquisition device obtains image data by imaging an object. An SDRAM 211 comprises a first storage area 211-1 for temporarily storing the image data obtained by the CCD 210.

An image processing unit 212 reads the mage data stored in the first storage area 211-1 to generate a YC signal from an RGB signal, and executes predetermined image processing such as JPEG compression. Additionally, the image processing unit 212 comprises a size changing section 212-1 which enlarges/reduces image data (original image data) at the time of image acquisition to generate new image data upon reception of an enlarged/reduced display instruction from a user. In the size changing here, sizes are changed in horizontal and vertical directions. In the size changing of the vertical direction, for example, image processing such as inserting or thinning is carried out. In the size changing of the horizontal direction, for example, 2-point interpolation or 4-point Cubic interpolation is used. The size changing in this case takes longer time because the obtained image data of a large data amount is enlarged/reduced. However, the image data after the enlargement/reduction becomes high in definition.

The SDRAM 211 comprises, in addition to the first storage area 211-1, a second storage area 211-2 for storing simple image data for displaying which is generated by thinning the original image data at the image processing unit 212 as an A image, and a third storage area 211-3 for storing image data generated by enlarging/reducing the original image data at the image processing section 212 as a B image. A recording medium 213 records many image data.

A video output unit 216 comprises a simple size changing section (referred to as Video Size Converter: VSC, hereinafter) 216-1 for sequentially generating image data different in size by using the simple image data stored in the second storage area 211-2 of the SDRAM 211. Since the image data used for enlargement/reduction here is image data of a small data amount in which the original image data is thinned, a processing speed is much higher. The embodiment provides a visually smooth zooming effect to the user by sequentially enlarging/reducing such simple image data and displaying them progressively.

A CPU 214 controls each portion in the camera. Especially, here, upon detection that the user has operated an operation button 215 to instruct enlarged/reduced display, the CPU 214 sends an instruction of changing a size of the image data to the size changing section 212-1 of the image processing unit 212 or the VSC 216-1 of the video output unit 216.

Next, an operation of the aforementioned configuration will be described. First, a flow up to displaying of the image data obtained by the CCD 210 without any size changing will be described. Image data obtained by imaging an object by the CCD 210 is temporarily stored in the first storage area 211-1 of the SDRAM 211. The stored image data is read by the image processing unit 212, subjected to image processing such as YC generation, and thinning to be made simple image data, and then stored in the second storage area 211-2 of the SDRAM 211. Subsequently, the image data read from the second storage area 211-2 is passed through the video output unit 216, converted into analog data by a DAC 217, and displayed on a TFT display 218. Alternatively, the image data is passed through the video output unit 216, encoded by an encoder 219, converted into analog data by a DAC 220, and then displayed on a TV apparatus 221.

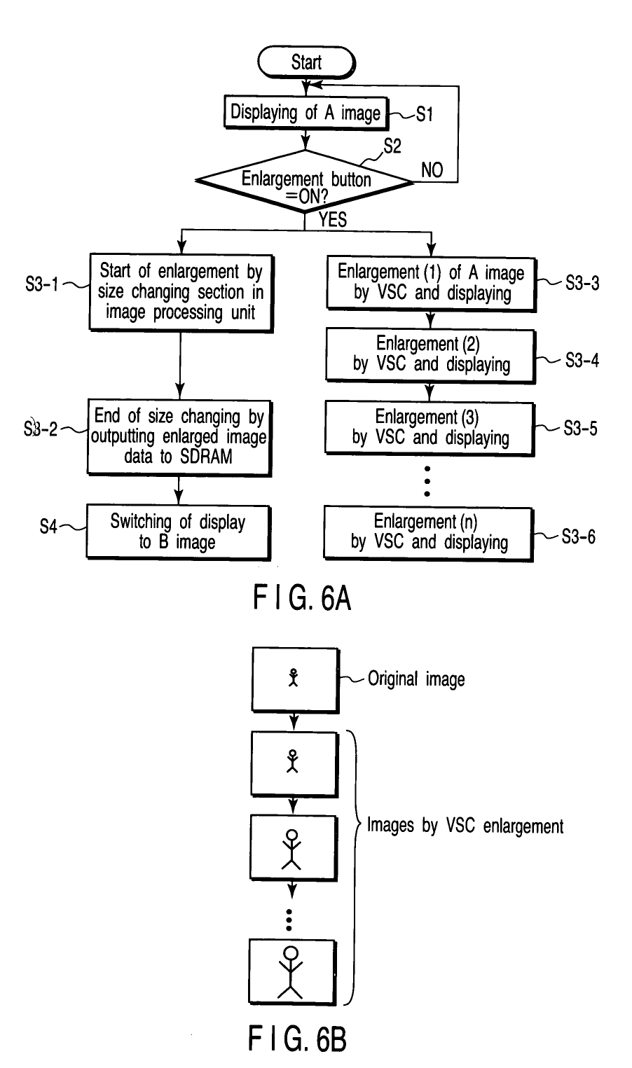

Next, referring to FIGS. 6A, 6B in addition to FIG. 5, the image data display method of the third embodiment will be described in detail. It is assumed that the image data obtained by the CCD 210 has been stored in the second storage area 211-2. First, the A image which is the simple image data stored in the second storage area 211-2 is displayed through the video output unit 216 on the TFT display 218 (step S1). Next, determination is made as to whether an enlargement button as the operation button 215 has been turned ON or not (step S2). The displaying of the A image continues if not ON. If ON, enlargement (size changing by first method) is started by the size changing section 212-1 in the image processing unit 212 (step S3-1). At the same time, the A image is sequentially enlarged (size changing by second method) and displayed progressively by the VSC 216-1 of the video output unit 216 (steps S3-3 to S3-6). In this case, enlargement is executed by an n number of times. FIG. 6B shows a situation in which an original image is sequentially enlarged and displayed by the VSC 216-1. Here, n can be optionally set. A visually smoother zooming effect can be provided to the user as n is getting larger. Additionally, in this case, since the A image as the simple image data is not image data at the time of image acquisition but image data of a reduced data amount for displaying, a time necessary for enlargement is short, and a time lag until displaying is relatively small.

On the other hand, the enlargement by the size changing section 212-1 has been finished by this time, and the enlarged image data is output as a B image to the third storage area 211-3 in the SDRAM 211 (step S3-2). Thus, after the enlarged display in the step S3-6, the B image is read from the third storage area 211-3, and sent through the video output unit 216 to the TFT display 218 to be displayed in place of the currently displayed A image (step S4).

### Fourth Embodiment

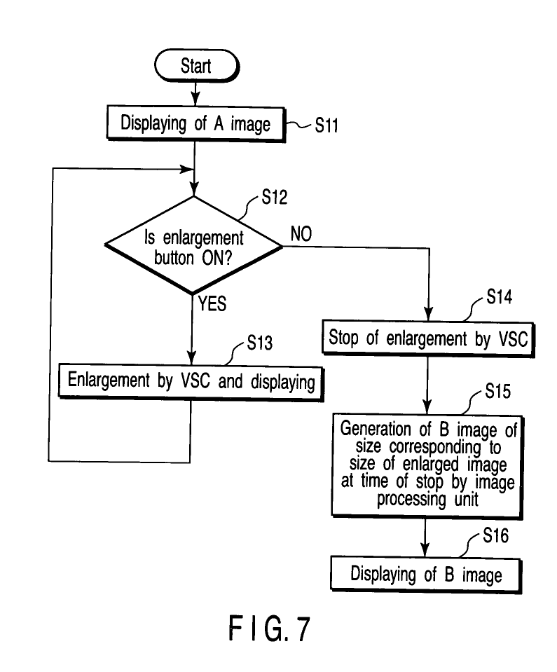

Next, referring to FIG. 7 in addition to FIG. 5, an image data display method of a fourth embodiment of the invention will be described in detail. First, an A image is read from a second storage area 211-2 and displayed on a TFT display 218 (step S11). Next, determination is made as to whether an enlargement button as an operation button 215 has been turned ON or not (step S12). If ON, the A image is enlarged to be displayed by a VSC 216-1 (step S13). Since the determination of the step S12 is YES while the enlargement button is depressed, the enlargement by the VSC 216-1 is sequentially executed (size changing by first method), and the enlarged image data is displayed progressively. When the enlargement button is turned OFF, the enlargement by the VSC 216-1 is stopped (step S14). A B image of a size corresponding to a size of the enlarged image at the time of stopping the enlargement is generated (generation by second method) by a size changing section 212-1 in an image processing unit 212 (step S15), and displayed on the TFT display 218 in place of the currently displayed A image (step S16).

### Fifth Embodiment

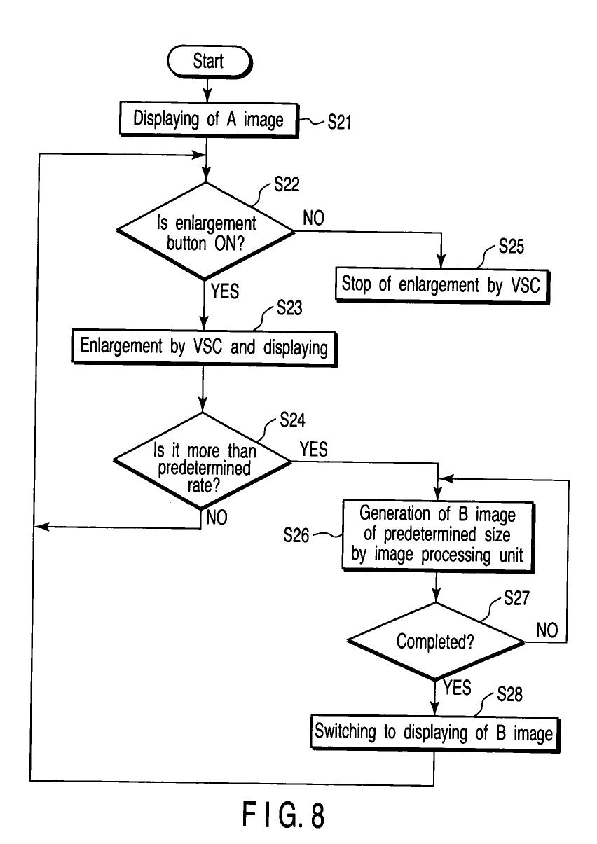

Next, referring to FIG. 8 in addition to FIG. 5, an image data displaying method of a fifth embodiment of the invention will be described in detail. First, an A image as simple image data is read from a second storage area 211-2, and displayed on a TFT display 218 (step S21). Next, determination is made as to whether an enlargement button as an operation button 215 has been turned ON or not (step S22). If ON, the A image is enlarged and displayed by a VSC 216-1 (step S23). Next, determination is made as to whether a rate of the enlargement of the step S23 exceeds a predetermined enlargement rate or not (step S24). If NO, the process of the steps S22, S23 and S24 is repeated. Accordingly, while the predetermined enlargement rate is not exceeded, the A image is sequentially enlarged by the VSC 216-1 (image data generation by first method), and the enlarged image data is displayed on the TFT display 218 progressively.

If it is determined in the step S24 that the predetermined enlargement rate is exceeded, processing to generate a B image of a predetermined size (image data generation by second method) is started in an image processing unit 212 (step S26). When the generation of the B image is completed (step S27), the B image is sent through a video output unit 216 to the TFT display 218, and displayed in place of the currently displayed A image (step S28). Subsequently, the process returns to the step S22 to repeat the steps thereafter. If the enlargement button is turned OFF in the step S22, the enlargement by the VSC 216-1 is stopped (step S25).

The display method of the invention when the image data is enlarged and displayed has been described. However, the invention can be applied to a case of reducing and displaying the image data. A system configuration in the case of reduced display is basically similar to that of FIG. 5.

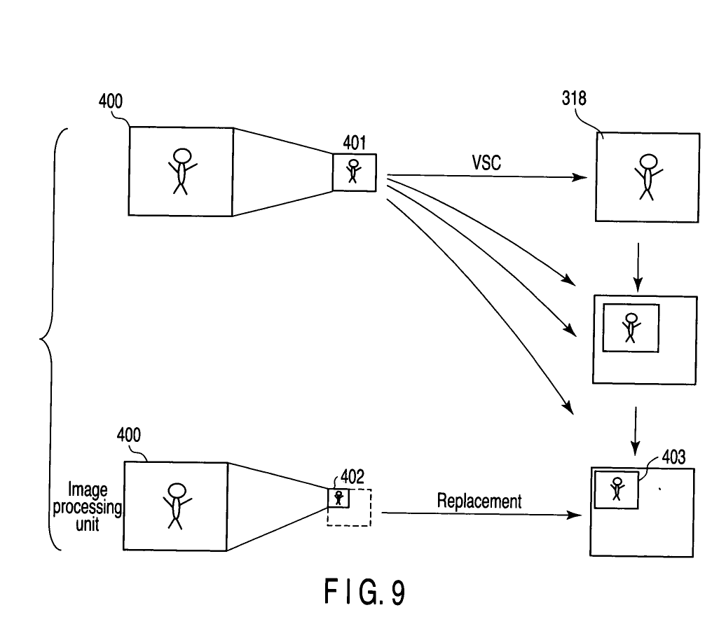

FIG. 9 is a view explaining a process when reduced display is carried out. Image data 401 for displaying in which image data (original data) 400 at the time of image acquisition is thinned to reduce a data amount is generated. The display image data 401 is sequentially reduced by the VSC 216-1 of FIG. 5, and displayed on the TFT display 218 progressively. In the meantime, at the image processing section 212-1, the obtained image data 400 is reduced to generate reduced image data 402 of a predetermined size. The image data 402 is reduced by the VSC 216-1, and displayed on the TFT display 218 in place of the reduced image 403 displayed at the time.

According to the third to fifth embodiments, the image for zooming displaying can be generated by a high quality at a high speed, and a visually smooth zooming effect can be provided to the user.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

1. An image processing apparatus which processes image data two-dimensionally arrayed in vertical and horizontal directions, comprising:
a vertical size changing section which changes a size of the image data in the vertical direction;
a horizontal size changing section which changes the size of the image data changed by the vertical size changing section in the horizontal direction; and
a display section which displays the image data changed in size in the vertical and horizontal directions.

2. The image processing apparatus according to claim 1, further comprising:
a size changing section which changes a size of the image data before the size changing of the vertical size changing section; and
a compressed data generation section which compresses the image data changed by the size changing section to generate compressed data for storage.

3. An image processing apparatus which processes image data two-dimensionally arrayed in vertical and horizontal directions, comprising:
a first storage section which stores the image data;
an image processing section which reads the image data stored in the first storage section to execute predetermined image processing therefor;
a size changing section which changes a size of the image data from the image processing section;
a vertical size changing section which changes the size of the image data from the size changing section in the vertical direction;
a second storage section which stores the image data from the vertical size changing section;
a horizontal size changing section which reads the image data stored in the second storage section to change the size of the image data in the horizontal direction; and
a display section which displays the image data changed in size in the vertical and horizontal directions.

4. An image processing apparatus which processes image data two-dimensionally arrayed in vertical and horizontal directions, comprising:
a vertical size changing section which changes a size of the image data in the vertical direction;
a storage section which stores the image data changed by the vertical size changing section;
a horizontal size changing section which reads the image data stored in the storage section to change the size of the image data in the horizontal direction; and
a display section which displays the image data changed in size in the vertical and horizontal directions.

5. An image processing method which processes image data two-dimensionally arrayed in vertical and horizontal directions, comprising:
a step of changing a size of the image data in the vertical direction;
a step of changing the size of the image data changed in the vertical direction in the horizontal direction; and
a step of displaying the image data changed in size in the vertical and horizontal directions.

6. An image processing apparatus which processes image data two-dimensionally arrayed in vertical and horizontal directions, comprising:
a size changing section which changes a size of the image data;
a JPEG processing section which executes JPEG compression for the image data changed by the size changing section;
a vertical size changing section which changes the size of the image data changed by the size changing section in the vertical direction in parallel with the JPEG compression of the JPEG processing section;
a horizontal size changing section which changes the size of the image data changed by the vertical size changing section in the horizontal direction; and
a display section which displays the image data changed in size in the vertical and horizontal directions.

7. An image processing apparatus which processes image data two-dimensionally arrayed in vertical and horizontal directions, comprising:
a storage section which stores the image data at least before execution of image processing and even after the execution of the image processing;
a first data sequence conversion section which reads, with a block of the two-dimensionally arrayed image data as a unit, the image data of the block from the storage section in a line direction, and then outputs the image data of the block in a column direction;
an image processing section which receives the image data output from the first data sequence conversion section in the column direction, changes a size of the image data and then outputs the image data in the column direction;
a second data sequence conversion section which converts the image data output from the image processing section in the column direction into image data of the line direction, and outputs the image data;
a JPEG processing section which executes JPEG compression for the image data of the line direction from the second data sequence conversion section;
a vertical size changing section which changes the size of the image data of the column direction from the image processing section in the vertical direction;
a third data sequence conversion section which converts the image data output from the vertical size changing section in the column direction into image data of the line direction, and outputs the image data;
a horizontal size changing section which changes the size of the image data of the line direction from the third data sequence conversion section in the horizontal direction; and
a display section which displays the image data changed in size in the vertical and horizontal directions.

8. The image processing apparatus according to claim 1, wherein the image data is moving image data.

9. The image processing apparatus according to claim 2, wherein the image data is moving image data.

10. The image processing apparatus according to claim 3, wherein the image data is moving image data.

11. The image processing apparatus according to claim 4, wherein the image data is moving image data.

12. The image processing apparatus according to claim 6, wherein the image data is moving image data.

13. The image processing apparatus according to claim 7, wherein the image data is moving image data.

14. The image processing apparatus according to claim 1, wherein the image data is obtained during imaging an object.

15. The image processing apparatus according to claim 2, wherein the image data is obtained during imaging an object.

16. The image processing apparatus according to claim 3, wherein the image data is obtained during imaging an object.

17. The image processing apparatus according to claim 4, wherein the image data is obtained during imaging an object.

18. The image processing apparatus according to claim 6, wherein the image data is obtained during imaging an object.

19. The image processing apparatus according to claim 7, wherein the image data is obtained during imaging an object.

20. The image processing apparatus according to claim 8, wherein the image data is obtained during imaging an object.

21. The image processing method according to claim 5, wherein the image data is moving image data.

22. The image processing method according to claim 5, wherein the image data is obtained during imaging an object.

23. An image data display method comprising:
a first step of changing a size of image data and displaying the image data; and
a second step of generating and displaying image data different from the image data changed and displayed by the size changing processing while the size of the image data is changed in the first step.

24. An image data display method comprising:
a step of starting processing to change a size of image data by a first method when changing of the size of the image data and displaying of the image data are instructed;
a step of sequentially generating and displaying image different in size by a second method different from that of the size changing processing while the size of the image data is changed; and
a step of replacing, upon completion of the size changing of the image data by the first method, the image data changed in size and displayed by the second method by the image data changed in size by the first method, and displaying the image data.

25. An image data display method comprising:
a step of sequentially generating, when changing of a size of image data and displaying of the image data are instructed, image data different in size by a first method while the size changing is instructed;
a step of stopping the size changing carried out by the first method when the size changing instruction is stopped;
a step of generating image data of a size corresponding to a size of the image data at the time of stopping the size changing carried out by the first method by a second method different from the first method; and
a step of replacing, upon completion of the generation of the image data by the second method, the image data changed in size and displayed by the first method by the image data generated by the second method and displaying the image data.

26. An image data display method comprising:
a first step of sequentially generating image data different in size by a first method when changing of a size of image data and displaying of the image data are instructed;
a second step of starting generation of image data changed in size by a second method different from the first method when a size changing rate of the image data exceeds a predetermined size changing rate during the displaying of the image data in the first step; and
a third step of replacing, upon completion of the generation of the image data by the second method, the image data changed in size and displayed by the first method by the image data generated by the second method and displaying the image data.

27. A digital camera comprising:
an image acquisition device which comprises pixels two-dimensionally arrayed in vertical and horizontal directions;
a vertical size changing section which changes a size of image data obtained by imaging an object by the image acquisition device in the vertical direction;
a horizontal size changing section which changes the size of the image data changed by the vertical size changing section in the horizontal direction; and
a display section which displays the image data changed in size in the vertical and horizontal directions.

28. The digital camera according to claim 27, further comprising:
a size changing section which changes the size of the image data before the size changing of the vertical size changing section; and
a compressed data generation section which compresses the image data changed by the size changing section to generate compressed data for storage.
